(19) United States
(12) Patent Application Publication
(10) Pub. No.: US 2019/0019090 A1
(43) Pub. Date: Jan. 17, 2019

(54) FIELD SERVICES PLATFORM

(71) Applicant: Accenture Global Solutions Limited, Dublin (IE)

(72) Inventors: Rubin George Chacko, Pune (IN); Trilok Rangan, Bangalore (IN); Rahul Chaudhary, Lucknow (IN)

(21) Appl. No.: 15/794,454

(22) Filed: Oct. 26, 2017

(30) Foreign Application Priority Data
Jul. 12, 2017 (IN) 201711024545

(51) Int. Cl. G06N 5/02; G06N 99/00

(52) U.S. Cl. CPC G06N 5/022; G06N 99/005

(57) ABSTRACT

Implementations are directed to a field services management (FSM) platform by providing a services layer including a plurality of micro-services, each micro-service executing one or more FSM tasks associated with an asset, providing at least one presentation layer including a plurality of channels, through which a user communicates with the FSP platform, receiving, by a virtual agent, and through a channel of the one or more channels, input data from one of the user and the asset, transmitting, by the virtual agent, at least a portion of the input data to an artificial intelligence (AI) system, receiving, by the virtual agent, response data from the AI system, the response data representing an intent, initiating at least one micro-service to perform at least one FSM task based on the intent, the at least one micro-service being performed based on interactions between the user and the virtual agent to progress through a work-flow of the at least one micro-service, and storing interaction data and asset data in a distributed ledger system (DLS).

### CROSS-REFERENCE TO RELATED APPLICATION

This application claims priority to Indian Patent Application No. 201711024545, filed on Jul. 12, 2017, entitled “FIELD SERVICES PLATFORM,” the entirety of which is hereby incorporated by reference.

### BACKGROUND

Enterprises can deploy products and/or services to its customers. For example, assets, such as physical devices, can be deployed by an enterprise to customer locations to perform services of the enterprise on behalf of the customer. Such assets can be referred to as being “in the field” (e.g., off-site, relative to locations of the enterprise). Field services management (FSM) can include a range of activities, referred to as field services, in support of managing assets that are deployed in the field. Example field services can include ordering, installation, repair, and/or replacement of an asset, analytics on asset performance, predictive asset maintenance, and the like. Field services can be performed by one or more agents of the enterprise. For example, an agent can assist with the ordering of assets, and/or scheduling maintenance. As another example, an agent, such as a technician, can be on-site at a customer location to install, and/or conduct maintenance on an asset.

### SUMMARY

Implementations of the present disclosure are generally directed to a field services management (FSM) platform. More particularly, implementations of the present disclosure are directed to a FSM platform provided as a service (PaaS).

In some implementations, actions include providing a services layer including a plurality of micro-services, each micro-service executing one or more FSM tasks associated with an asset, providing at least one presentation layer including a plurality of channels, through which a user communicates with the FSP platform, receiving, by a virtual agent, and through a channel of the one or more channels, input data from one of the user and the asset, transmitting, by the virtual agent, at least a portion of the input data to an artificial intelligence (AI) system, receiving, by the virtual agent, response data from the AI system, the response data representing an intent, initiating at least one micro-service to perform at least one FSM task based on the intent, the at least one micro-service being performed based on interactions between the user and the virtual agent to progress through a work-flow of the at least one micro-service, and storing interaction data and asset data in a distributed ledger system (DLS). Other implementations of this aspect include corresponding systems, apparatus, and computer programs, configured to perform the actions of the methods, encoded on computer storage devices.

These and other implementations can each optionally include one or more of the following features: the input data includes text data received through a messaging application of the at least one presentation layer, the text data being processed by a natural language processing (NLP) engine of the AI system to determine the intent, the input data includes asset parameter data representative of operating conditions of the asset, the asset parameter data being processed by a machine-learned model of the AI system to determine the intent, the at least one FSM task includes registering, by a registration service of the FSM platform, the asset to be managed by the FSM platform, registering including determining an asset-specific fingerprint, and submitting a registration entry to the DLS based on the asset-specific fingerprint; the at least one FSM task includes initiating an incident for the asset, the incident comprising performing maintenance on the asset; actions further include executing a scheduling micro-service to schedule a maintenance visit of a technician to the asset; actions further include, during the maintenance visit, transmitting one or more of asset-related data, and asset-specific data to a device of the technician, the one or more of asset-related data, and asset-specific data being displayed as one or more overlays in one or more of a virtual reality (VR), augmented reality (AR), and merged reality (MR) environment provided by the device to assist the technician in resolving the incident; and actions further include storing audit data to the DLS upon completion of the maintenance.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF DRAWINGS

FIG. 1 depicts an example high-level architecture in accordance with implementations of the present disclosure.

FIG. 2 schematically depicts an example platform architecture in accordance with implementations of the present disclosure.

FIG. 3 schematically depicts an example conceptual architecture in accordance with implementations of the present disclosure.

FIGS. 4A-4C depict example graphical user interfaces (GUIs) in accordance with implementations of the present disclosure.

FIG. 5 depicts an example process for providing contextual data in accordance with implementations of the present disclosure.

### DETAILED DESCRIPTION

Implementations of the present disclosure are generally directed to a field services management (FSM) platform. More particularly, and as described in further detail herein, implementations of the present disclosure are directed to a FSM platform provided as a service (PaaS). The FSM platform of the present disclosure can be described as a serverless, microservices-based platform for streamlining field services using artificial intelligence (AI), a virtual (digital) assistant, industrial Internet-of-things (IoT) devices, edge analytics, a distributed ledger system (e.g., Blockchain), as well as IoT device transactions, and auditing transactions.

In some implementations, actions include providing a services layer including a plurality of micro-services, each micro-service executing one or more FSM tasks associated with an asset, providing at least one presentation layer including a plurality of channels, through which a user communicates with the FSP platform, receiving, by a virtual agent, and through a channel of the one or more channels, input data from one of the user and the asset, transmitting, by the virtual agent, at least a portion of the input data to an artificial intelligence (AI) system, receiving, by the virtual agent, response data from the AI system, the response data representing an intent, initiating at least one micro-service to perform at least one FSM task based on the intent, the at least one micro-service being performed based on interactions between the user and the virtual agent to progress through a work-flow of the at least one micro-service, and storing interaction data and asset data in a distributed ledger system (DLS).

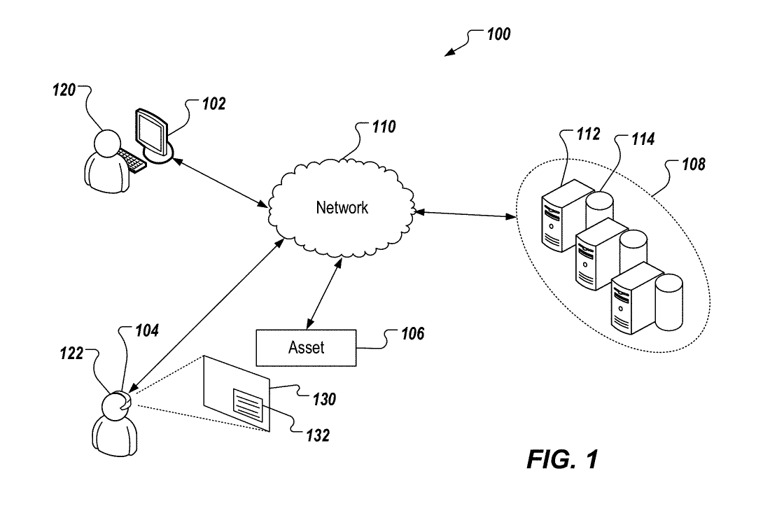

FIG. 1 depicts an example system 100 that can execute implementations of the present disclosure. The example system 100 includes computing devices 102, 104, an asset 106, a back-end system 108, and a network 110. In some implementations, the network 110 includes a local area network (LAN), wide area network (WAN), the Internet, or a combination thereof, and connects web sites, devices (e.g., the computing device 102, 104), assets (e.g., the asset 106), and back-end systems (e.g., the back-end system 108). In some implementations, the network 110 can be accessed over a wired and/or a wireless communications link. For example, mobile computing devices, such as smartphones, can utilize a cellular network to access the network 110.

In the depicted example, the back-end system 108 includes at least one server system 112, and data store 114 (e.g., database). In some implementations, the at least one server system 112 hosts one or more computer-implemented services that users can interact with using computing devices. For example, the server system 112 can host a FSM platform in accordance with implementations of the present disclosure. In some implementations, back-end system 108 represents computer systems utilizing clustered computers and components to act as a single pool of seamless resources when accessed through a network. For example, such implementations may be used in data center, cloud computing, storage area network (SAN), and network attached storage (NAS) applications.

In some implementations, the computing devices 102, 104 can each include any appropriate type of computing device such as a desktop computer, a laptop computer, a handheld computer, a tablet computer, a wearable device, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In the depicted example, the computing device 102 is provided as a desktop computer, and the computing device 104 is provided as a wearable device.

In accordance with implementations of the present disclosure, respective users 120, 122 of the computing devices 102, 104 can interact with the back-end system 108 to interact with the FSM platform in accordance with implementations of the present disclosure. For example, and as described in further detail herein, the user 120 can be an agent of a customer of the enterprise, who interacts with the FSM platform to manage assets (e.g., order assets, request service). As another example, the user 122 can include an agent of the enterprise, who is deployed in the field to assist an installation and/or repair of assets (e.g., a technician).

In the depicted example, the asset 106 can include any appropriate device deployed in the field by an enterprise to perform one or more services for a customer of the enterprise. In a non-limiting example, the asset 106 can include an industrial pump for pumping fluids at a customer location. In some examples, the asset 106 is provided as, and/or includes one or more IoT devices. Accordingly, the asset 106 transmits data to and receives information from the FSM platform hosted on the back-end system 108. For example, the asset 106 can provide data representative of parameter measurements (e.g., temperature, pressure, speed) to the back-end system 108. As another example, the asset 106 can provide data representative of asset-specific parameters (e.g., unique identifier, model number, software version) to the back-end system 108.

As introduced above, implementations of the present disclosure provide a FSM platform to monitor and assist in the performance of one or more field services for assets deployed in the field. Implementations of the present disclosure will be described in further detail herein with reference to an example context. The example context includes FSM of assets including industrial equipment, example industrial equipment including a steam turbine, and an industrial cooling machine. It is contemplated, however, that implementations of the present disclosure can be realized in any appropriate field services context with any appropriate assets.

In general, the FSM platform of the present disclosure is provided as a PaaS that enables multiple customers (e.g., different enterprises) to leverage the platform in performing FSM activities. For example, each customer can be assigned in instance of the FSM platform, which is separate and distinct from instances of other customers. Accordingly, the FSM platform includes a platform manager that enables management of multiple customer instances, and connection to customer platforms. In some examples, the FSM platform includes a monetization scheme, through which a customer pays for services the FSM platform provides. For example, a customer can pay for use of the FSM platform on a subscription basis (e.g., monthly fees, annual fees). As another example, a customer can pay for use of the FSM platform on a per-use basis (e.g., per asset registered with the FSM platform).

In some implementations, and as described in further detail herein, the FSM platform provides channels, through which agents (e.g., customers, service technicians) can interact with the FSM platform. In some examples, the channels are provided in one or more presentation layers. Example channels include applications, virtual agents (bots), dashboards, and the like. For example, an application can include a messaging application (e.g., Skype for Business provided by Microsoft), through which an agent of a customer can communicate with the platform (e.g., type text into the application, speak into the application, speech being converted to text by the platform). In some examples, input (e.g., text data) from a customer is processed by one or more virtual agents, that communicate with the customer through the respective channel (e.g., messaging application). A virtual agent can be provided as a bot, which can be described as a semi-autonomous software application that automatically performs FSM tasks, as described herein.

In some implementations, the FSM platform leverages AI to support communication between the virtual agent and the customer, and to perform FSM tasks. For example, AI modules can be accessed to perform natural language processing (NLP), machine-learning (ML), and the like. In this manner, an intent of a customer can be determined, and an appropriate service can be initiated to perform a customer-requested FSM task. In some implementations, the FSM platform provides a plurality of services, each provided as a plurality of micro-services, which can be initiated to perform a respective workflow in response to the customer request. That is, for example, upon determining what the customer is requesting, the virtual agent can initiate an appropriate service to conduct a workflow in performing the FSM task.

For example, and as described in further detail herein, a customer can communicate with the platform to register assets with the FSM platform. The customer's communications (e.g., to a virtual agent, through a messaging application) can be processed through one or more AI components (e.g., NLP) to determine that the customer is requesting to register an asset. In response, the virtual agent can initiate a registration workflow that is performed using a registration service (micro-service) of the FSM platform.

As another example, and as described in further detail herein, one or more parameters of an asset can be monitored, and can be processed through one or more AI components (e.g., a machine-learned predictive model) to determine that the asset requires maintenance. In response, the virtual agent can initiate an incident workflow that is performed using an incident management service, as well as one or more other services (e.g., a scheduling service to schedule a technician visit to the asset). In some examples, the virtual agent communicates with the customer through one or more channels to perform incident management (e.g., scheduling the technician visit in a calendar of the customer, sending an email to the customer, communicating with the customer through the messaging application).

In some implementations, and as described in further detail herein, the FSM platform leverages a DLS to immutably store data. An example DLS includes Blockchain. In general, the FSM platform interacts with the DLS to store asset-specific data, audit data, and the like.

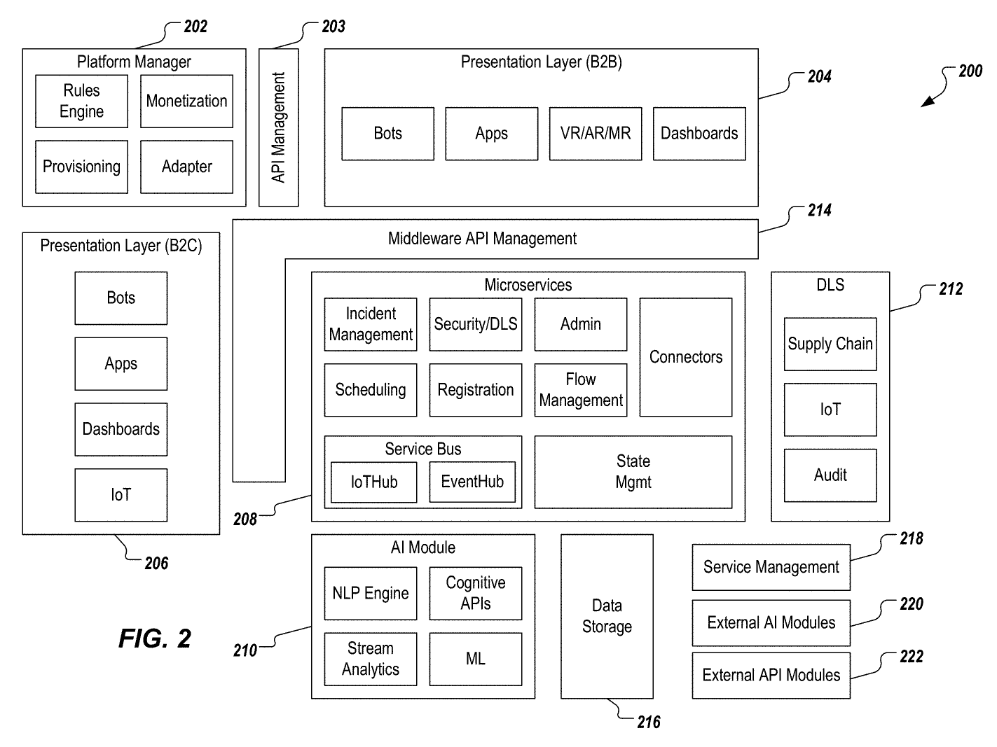

FIG. 2 schematically depicts an example platform architecture 200 in accordance with implementations of the present disclosure. The example platform architecture 200 provides the FSM platform of the present disclosure. In the depicted example, the example platform architecture 200 includes a platform manager 202, a business-to-business (B2B) presentation layer 204, a customer-to-business (C2B) presentation layer 206, a micro-services layer 208, an artificial intelligence (AI) module 210, a distributed ledger system (DLS) 212, and a middleware management layer 214. The example platform architecture 200 further includes a data storage layer 216, a services management system 218, one or more external AI modules 220, and one or more external API modules 222.

In the depicted example, the platform manager 202 includes a rules engine, a provisioning module, a monetization module, and an adapter module. In some examples, the platform manager 202 provides a customer-specific segment within the FSM platform that is accessible only by the customer (e.g., agents of the customer). In this manner, the FSM platform can be provided as a service (e.g., platform-as-a-service (PaaS)), such that multiple customers can access the FSM platform in their respective segments, keeping customer data/information isolated from one another. In some examples, the FSM platform (e.g., the platform manager 202) is exposed through a platform API management layer 203.

In some examples, the rules engine processes information received by the FSM platform through one or more rules to determine one or more actions to be taken. Example rules can include evaluating a privilege and/or authorization (e.g., authentication) of a user logging into the FSM platform, evaluating rules regarding one or more services the customer has subscribed to (e.g., NLP service, ServiceNow integration, bots, HoloLens), and enabling scripts for such services to be executed, as well as providing access and permissions for scripts spawning other services/modules of the platform architecture 200.

In some examples, the monetization module manages subscriptions of companies to the FSM platform, enabling each company, for example, to select services of the FSM platform. The monetization module also manages costs/fees for customer use of the FSM platform. For example, a fixed cost on the as a service FSM subscription model for all services can be provided. As another example, cost can be determined case-by-case (e.g., based on the services available to the platform and customization work needed, if any). In some examples, the provisioning module uses data from the rules engine and the monetization module to initiate provisioning of the presentation layers, and services for each customer based on configurable scripts. In some examples, the adapter module changes the services and/or presentation layers created by running provisioning module, and executes customizations scripts (or actual coding) as needed to adapt the FSM platform to the exact customer requirements.

In the depicted example, the B2B presentation layer 204 includes one or more bots (virtual agents), one or more applications, a virtual-reality (VR), augmented-reality (AR), and/or a mixed-reality (MR) system, and one or more dashboards. In some examples, the B2B presentation layer 204 enables agents of the enterprise to interact with the FSM platform. For example, an agent can converse with the FSM platform through a messaging application to, for example, order components. As another example, the agent can view one or more dashboards regarding assets of customers (e.g., workflow progress, open incidents, resolved incidents), as described in further detail herein.

In one example, the VR/AR/MR module can enable use of a VR/AR/MR system for performing maintenance on an asset. An example VR/AR/MR system includes Hololens provided by Microsoft. For example, a technician of the enterprise can be assigned the task of performing maintenance on an asset. The VR/AR/MR system can be used by the technician to view the asset in VR/AR/MR, where a VR/AR/MR device provides views, animations, and/or instructions to the technician in completing the task. For example, and with reference to FIG. 1, the user 122 can use the device 104 to view the asset 106 with one or more overlays of instructions, views, and/or animations for conducting maintenance on the asset 106 (e.g., overlay instructions describing and animating how to remove and replace a sub-component of the asset). In some examples, asset-related data (e.g., a maintenance manual for the type of pump) can be retrieved from the data storage layer 216, and asset-specific data (e.g., IoT data recorded for the specific asset) can be retrieved from the DLS 212. The asset-related data, and/or the asset-specific data can be displayed to the technician through the VR/AR/MR system. For example, while the technician is looking at the asset, a maintenance manual can be provided in a view (e.g., a view 130 of FIG. 1) as an overlay (e.g., an overlay 132 of FIG. 1), such that the technician can view the asset and the maintenance manual concurrently (e.g., through the device 104). As another example, while the technician is looking at the asset, asset-specific data (e.g., temperature, pressure, speed) can be provided as an overlay, such that the technician can view the asset and the asset-specific data concurrently (e.g., through the device 104).

In the depicted example, the C2B presentation layer 206 includes one or more bots, one or more applications, one or more dashboards, and an IoT module. In some examples, the C2B presentation layer 206 enables the customer (e.g., agents of the customer) to interact with the FSM platform. For example, the applications can include a messaging application, through which a customer can communicate with a chat bot (e.g., virtual agent), as described in further detail herein. In some examples, a customer can view one or more dashboards that summarize asset status (e.g., asset condition based on IoT data), and/or progress of resolving incidents related to the customer's assets (e.g., incident logged, parts ordered, maintenance appointment scheduled).

In the depicted example, the B2B presentation layer 204, and the C2B presentation layer 206 communicate with the micro-services layer 208, and/or the AI module 210 through the middleware API management layer 214. For example, text data provided through a messaging application (e.g., on the B2B presentation layer, or the C2B presentation layer) is provided to the AI module 210 to perform one or more AI-related tasks (e.g., determining an intent to register an asset). One or more services of the micro-services layer 208 can communicate with a presentation layer through the middleware API management layer 214. For example, a registration workflow provided by the registration service can be initiated based on input form the AI module 208 that indicates that a user is requesting to register an asset, the registration service communicating with the user through the messaging application. In this manner, the micro-services layer 208, in hand with the AI module 210 can operate to perform functionality provided by the FSM platform through interactions channeled through the presentation layers.

In the depicted example, the micro-services layer 208 includes multiple micro-services. In some examples, a micro-service can be described as an application that is made up of multiple, independently deployable, modular services, each service running a unique process and communicating with other services to perform one or more functions. In the depicted example, the micro-services layer includes an incident management service, a security/DLS service, an administration service, a scheduling service, a registration service, a flow management service, a connectors service, a service bus including an IoT hub, and an event hub, and a state management service.

In the depicted example, the AI module 210 includes a NLP engine, a machine-learning (ML) module, a stream analytics module, and one or more cognitive APIs. In some examples, the NLP engine receives text data and processes the text data to perform one or more NLP tasks. Example NLP tasks can include tokenization, sentence segmentation, part-of-speech tagging, named entity extraction, chunking, parsing, and coreference resolution. In accordance with implementations of the present disclosure, the NLP engine processes text data (e.g., received from a customer through a messaging application) to determine a customer intent, and provide responses to the customer to perform a FSM task. For example, and as described herein, the text data can indicate a customer's intent to register an asset with the FSM platform, and/or to initiate a maintenance ticket.

In some examples, the ML module executes one or more ML applications. Example ML applications can be provided using Microsoft Azure Machine Learning provided by Microsoft. In some examples, the stream analytics module performs data analytics on the asset data (e.g., IoT data) that is received by the FSM platform. An example stream analytics systems includes the Microsoft Azure Stream Analytics provided by Microsoft. In some examples, the one or more cognitive APIs enable access to one or more third-party cognitive services. Example cognitive services can include emotion and sentiment detection, vision and speech recognition, language understanding, knowledge, and search. An example third-party includes Microsoft, which provides the Microsoft Azure suite of cognitive services that can be accessed through the one or more cognitive APIs.

In some implementations, stream analytics can be provided using edge devices. For example, Azure Stream Analytics can be provided on the edge (e.g., IoT devices) to remove recurring data, and avoid network throttling, detect non-working or non-polling devices, detect alerts to be handled locally (e.g., extreme high vibration where machine needs to be immediately switched off). In some implementations, stream analytics can be provided on the cloud. For example, Cloud Azure Stream Analytics can be used to process IoT data, and identify long term alert patterns based on reference blob data uploaded by the manufacturer backend, and cross-reference with machine-learnt predictive breakdown patterns.

In some examples, historic data is dumped in to the Azure Data lake, where novelty detection algorithms to identify future break down patterns even before it occurs. Novelty detection can be described as the identification of new or unknown data that a ML system is not aware of during training. For example, conventional monitoring of assets (e.g., operating conditions) relies on known abnormal condition(s). However, some conditions may not be known. Accordingly, novelty detection identifies departures from a model of normality, and maximizes detection of true novel samples, while minimizing false positives. For novelty detection, the description of normality is learnt by fitting a model to the set of normal examples, and previously unseen patterns are tested by comparing respective novelty scores (as defined by the model).

In the depicted example, the DLS 212 includes a supply chain segment, an IoT segment, and an audit segment. In some examples, the supply chain segment immutably stores data related to assets. For example, an asset can be indexed by an asset-specific fingerprint (e.g., a unique asset identifier), and data associated with the asset can be stored within the supply chain segment. In some examples, the IoT segment immutably stores IoT data associated with respective assets (e.g., data received from the asset, and/or from IoT devices monitoring the asset over an operational lifetime of the asset). In some examples, the audit segment immutably stores audit data associated with respective assets. For example, in repairing an asset, a technician can collect data (e.g., an image of the asset), which data can be stored as audit data associated with the asset.

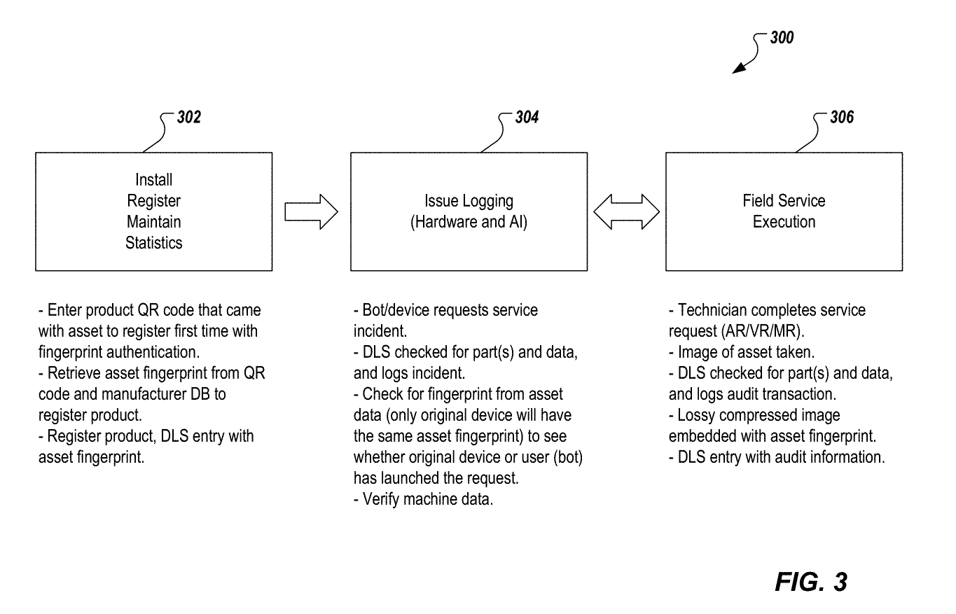

In some implementations, FSM can include multiple stages supported by the FSM platform. FIG. 3 depicts an example conceptual flow 300 in accordance with implementations of the present disclosure. Example stages can include asset installation and registration 302, request handling 304, and asset maintenance 306. In some examples, during installation and registration, a customer orders an asset, the asset is installed at a customer location, and is registered with the FSM platform. For example, a customer interacts with a virtual agent through a channel (e.g., a bot framework through a messaging application).

In an example based on the example context, a customer can contact the FSM using a messaging application to register a steam turbine that has been ordered and installed. For example, a message sent through the messaging application can trigger opening of a warranty and service (W/S) bot to register the asset for warranty and maintenance (e.g., through the registration service). In some example, the W/S bot requests information associated with the asset. For example, the customer can provide an image of a machine-readable code (e.g., barcode, QR code) associated with the asset, which the FSM platform can decode to determine asset-specific information (e.g., unique identifier, asset type, date of manufacture, date of installation, etc.). An asset-specific fingerprint can be provided (e.g., read form the QR code), which is unique to the respective asset. In some examples, the W/S bot logs the asset-specific information, and/or registration to a secure server, and/or the DLS. In some examples, the asset fingerprint can include registration data, and/or post-installation data. Example registration data includes a unique warranty number, service due dates, manufacturer ID, asset ID, and timestamp(s). Example post-installation data can include the registration data, as well as IoT data, vibration pattern(s) (e.g., machine heartbeat patterns, which uniquely identifies a machine, MAC ID, and network ID. In some examples, the asset registration is entered in the DLS (e.g., a registration block is added to the blockchain) with the asset fingerprint.

An example dialogue within the messaging application (e.g., the user 120 communicating with the virtual agent of the FSM using the computing device 102, in FIG. 1) can be provided as:
Customer: Hi!
Bot: Hi [NAME], how can I help you?
Customer: I have installed a new steam turbine in the factory, and would like to register it for alert services.
Bot: Please send your product(s) QR code image(s) or send the OTP (for buying a resale item).
Customer: [QR code image]
Bot: Brand Name: Steam Turbine V6; Product Name: Steam Turbine; Date of Purchase: Jul. 15, 2017, 12:00 AM; Seller: Acme Machine Parts; Warranty Number: 982323; Service Due: Dec. 1, 2017, 12:00 AM; Price: $320,000; Warranty End Date: Dec. 31, 2018, 12:00 AM.
Bot: Your Product Contract has been successfully generated for 1 item(s).
Customer: Great, thanks. I would like to receive alerts for when service is due for the steam turbine.
Bot: Not a problem. We have the Steam Turbine registered to have alerts issued when service is due.
Bot: Is there anything else I can help you with?
Customer: Not today, thanks!
Bot: Goodbye.

In some examples, during request handling, asset activity, and/or customer activity is monitored, and a ticket can be initiated to address one or more potential issues associated with an asset. For example, operational data of the asset (e.g., IoT data) can be periodically received by the FSM platform, which can process the operational data (e.g., through a machine-learned predictive model) to identify one or more potential issues, and/or a service event that is otherwise due. In another example, the customer can report a concern to the FSM using the messaging application. An example dialogue within the messaging application (e.g., the user 120 communicating with the virtual agent of the FSM using the computing device 102, in FIG. 1) can be provided as:
Customer: Hi. I need to report a problem with Steam Turbine.
Bot: Okay, what seems to be the problem?
Customer: The steam turbine has had high vibrations over the last 2-3 days.
Bot: The issue has been registered, and has been assigned incident number INC0010079.

In response to an incident, an incident workflow (e.g., performed using the incident management service) can be initiated to resolve the incident. Example steps in the incident workflow can include launch incident, order replacement part(s) (if needed), assign a service technician, obtain service approval, replace part(s) (if needed), conduct audit, and close incident. In some examples, a step in the incident workflow can include its own workflow. For example, the replace part(s) step can include a part replacement workflow including example steps of order part, package part, ship part, deliver part. As another example, the conduct audit step can include an audit workflow including steps of upload asset image to datastore, add audit entry to DLS, and complete audit.

Continuing with the example above, it can be determined that a replacement part is needed. An example dialogue within the messaging application (e.g., the user 120 communicating with the virtual agent of the FSM using the computing device 102, in FIG. 1) can be provided as:
Bot: With respect to repair of Steam Turbine recorded in incident number INC0010079, a replacement part is being ordered. Part replacement order REQ0010032 has been assigned.
Bot: Trilok Rangan will be the approver for this request.
. . .
Bot: Trilok Rangan has approved the request. You can track the replacement part order using item number RITM0010025

In some examples, in response to the replacement part order request, a message is communicated to the approver (e.g., Trilok Rangan in the above example). For example, an email message can be sent. The message can include a channel, through which the approver can approve the request. For example, an email can include a hyperlink that the approver can click on to approve or deny the request.

In some examples, during asset maintenance, one or more technicians attend to an asset for scheduled maintenance, and/or in response to a ticket. Continuing with the example above, it can be determined that maintenance is to be scheduled to install the replacement part. An example dialogue within the messaging application (e.g., the user 120 communicating with the virtual agent of the FSM using the computing device 102, in FIG. 1) can be provided as:
Bot: Rubin George Chacko has been assigned as the repair technician to resolve incident number INC0010079.
Bot: An appointment for Rubin George Chacko has been scheduled for 2017 Aug. 6 at 10 AM. This appointment has been added to your calendar.

In some implementations, and as described herein, the technician can use a device (e.g., the device 106 of FIG. 1) to provide VR/AR/MR functionality. For example, while the technician is looking at the asset, a maintenance manual can be provided as an overlay, such that the technician can view the asset and the maintenance manual concurrently (e.g., through the device 104). As another example, while the technician is looking at the asset, asset-specific data (e.g., temperature, pressure, speed) can be provided as an overlay, such that the technician can view the asset and the asset-specific data concurrently (e.g., through the device 104).

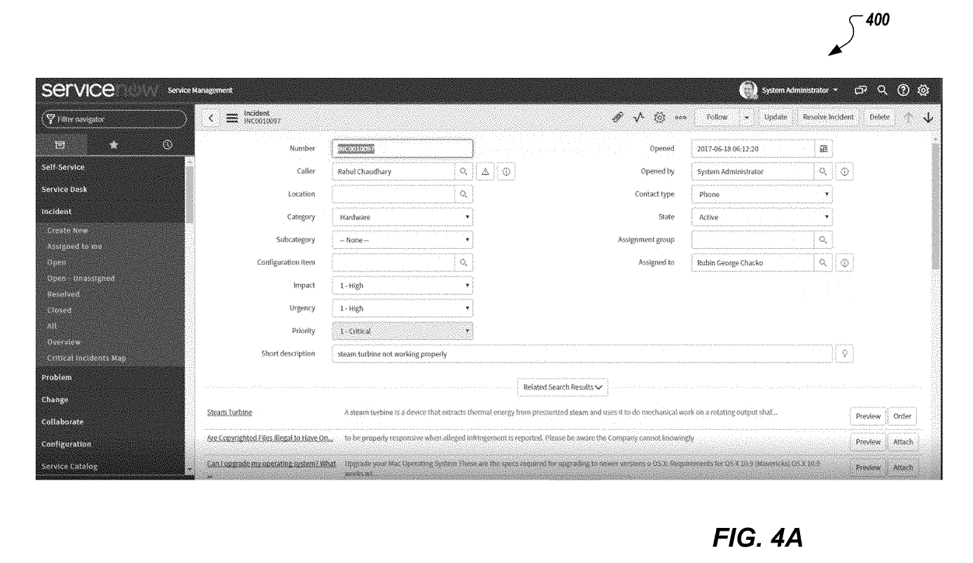

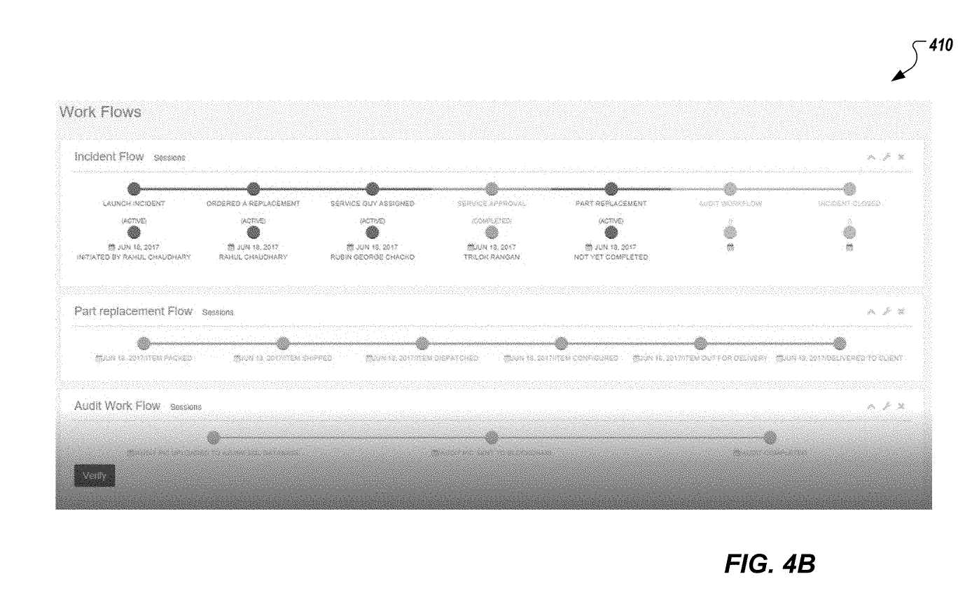

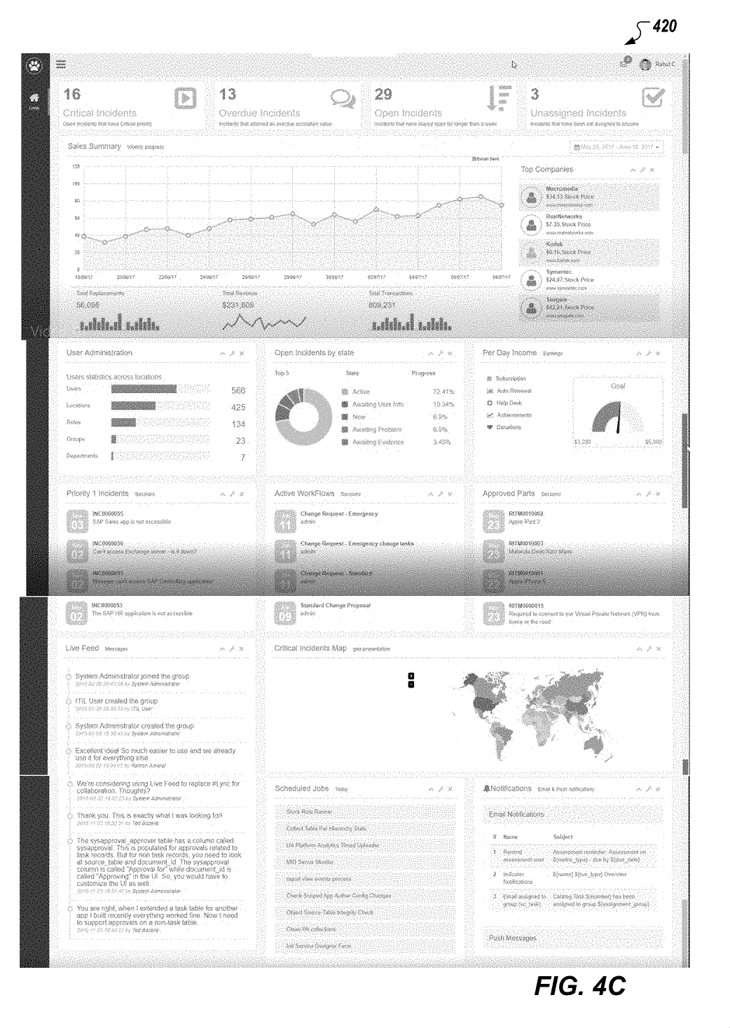

FIGS. 4A-4C depict example graphical user interfaces (GUIs) in accordance with implementations of the present disclosure.

FIG. 4A depicts an example service management GUI 400 (e.g., provided through the B2B presentation layer 204). In the depicted example, the service management GUI 400 is provided by a third-party service management system. The service management GUI 400 enables an agent of the enterprise to manage incidents, such as maintenance incidents described above. In the depicted example, the service management GUI 400 includes information associated with incident number INC0010079 provided form the example above.

FIG. 4B depicts an example workflow dashboard 410 (e.g., provided through the B2B presentation layer 204). In some examples, the workflow dashboard 410 enables an agent of the enterprise to monitor the progress of respective workflows. In the depicted example, example workflows are provided as an incident workflow, a part replacement workflow, and an audit workflow. In some examples, each workflow is provided as a graphical representation including steps to be performed in completing the workflow, and a status of each step (e.g., active, completed, packaged, shipped, etc.) is provided.

FIG. 4C depicts an example incidents dashboard 420 (e.g., provided through the B2B presentation layer 204). In some examples, the incidents dashboard 420 enables an agent of the enterprise to view the status of incidents across assets of one or more customers.

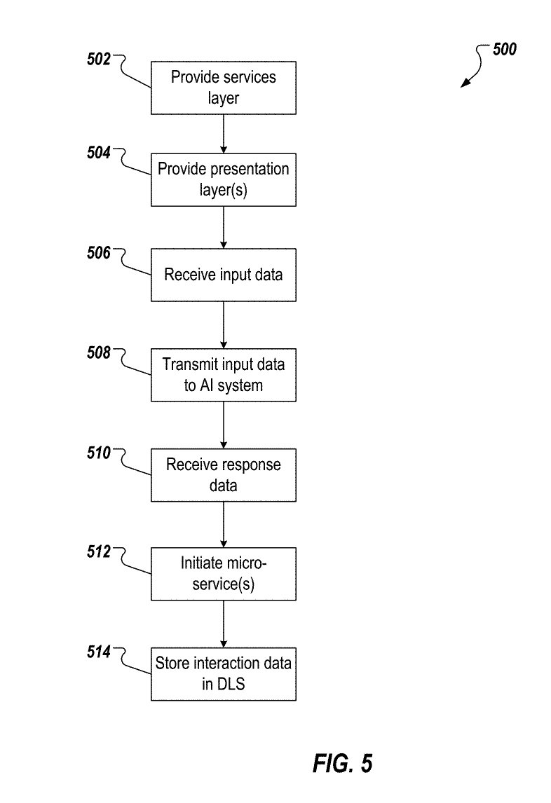

FIG. 5 depicts an example process 500 that can be executed in accordance with implementations of the present disclosure. In some implementations, the example process 500 is provided using one or more computer-executable programs executed by one or more computing devices (e.g., the back-end system 108 of FIG. 1).

A services layer is provided (502). For example, the FSM platform provides the micro-services layer 208, which includes a plurality of micro-services, each micro-service executing one or more FSM tasks associated with an asset. The asset is a real-world, physical device. At least one presentation layer is provided (504). For example, the FSM platform provides the B2B presentation layer 204, and the C2B presentation layer 206. The presentation layer includes a plurality of channels, through which a user communicates with the FSP platform. An example channel include a messaging application, which the user can use to communicate with a virtual agent of the FSM platform.

Input data is received (506). For example, input data can include text data that is received from the user through a channel (e.g., the user inputting text data into a messaging application). As another example, the input data can include asset parameter data representative of operating conditions of the asset. For example, the input data can be provided as IoT data from the asset, and/or from one or more IoT devices monitoring the asset. At least a portion of the input data is transmitted to an AI system (508). For example, the micro-services layer 208 (e.g., a virtual agent provided therein) transmits at least a portion of the input data to the AI module 210. Response data is received from the AI system (510). In some examples, the response data represents an intent. For example, the AI module 210 processes the input data using the NLP engine, and/or a machine-learned model to determine intent.

At least one micro-service is initiated based on the response data (512). In some examples, the at least one micro-service performs at least one FSM task based on the intent, the at least one micro-service being performed based on interactions between the user and the virtual agent to progress through a work-flow of the at least one micro-service. Interaction data and asset data are stored in the DLS. In some examples, the interaction data is representative of interactions performed in execution of the at least one FSM task (e.g., registration, scheduling).

Implementations of the present disclosure achieve one or more of the following example advantages. The FSM platform of the present disclosure is plug-and-play, providing configurable bot (e.g., chat bot) integration with one or more backend providers (e.g., Microsoft Azure, ServiceNow, HoloLens). The FSM platform also provides edge-based IoT analytics for real-time feedback (e.g., edge execution of customized algorithms (vibration monitoring, novelty detection)). The FSM platform further provides mixed reality applications to assist in performing service activities. For example, mixed reality based 3D holograms are provided that create a digital twin of the actual asset. Use of mixed reality avoids hazards of other system that, for example, are completely immersive, and/or superimpose data and objects, distracting user from the surroundings. Implementations further provide offline image recognition for a wearable devices (without internet connectivity), voice detection, hands-free operation, context recognition and personalization, digital 3D dashboards, augmented workflows, automated auditing feature (with blockchain integration), and proximity detection and surrounding awareness for hazard detection with warnings. With regard to DLSs, implementations use a DLS (e.g., blockchain) in bots for digital warranties, for example, reducing insurance overheads by fixing accountability at each stakeholder—manufacturer, 3^{rd} party AMCs, the company themselves, IoT data check from machine fingerprinting to avoid fake data and fix accountability of services, audit images steganography with real-time data, timestamps and voice samples from service engineer, and provide a real-time Blockchain dashboard to monitor and verify transactions. Further, the FSM platform implements a liquid, microservices-based middleware for plug and play of multiple different backends or technology platforms.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products, i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any appropriate kind of digital computer. Generally, a processor will receive instructions and data from a read only memory or a random access memory or both. Elements of a computer can include a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

To provide for interaction with a user, implementations may be realized on a computer having a display device, e.g., a CRT (cathode ray tube) or LCD (liquid crystal display) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any appropriate form of sensory feedback, e.g., visual feedback, auditory feedback, or tactile feedback; and input from the user may be received in any appropriate form, including acoustic, speech, or tactile input.

Implementations may be realized in a computing system that includes a back end component, e.g., as a data server, or that includes a middleware component, e.g., an application server, or that includes a front end component, e.g., a client computer having a graphical user interface or a Web browser through which a user may interact with an implementation, or any appropriate combination of one or more such back end, middleware, or front end components. The components of the system may be interconnected by any appropriate form or medium of digital data communication (e.g., a communication network). Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A computer-implemented method for providing a field service management (FSM) platform as a service, the method being executed by one or more processors and comprising:
providing, by the one or more processors, a services layer comprising a plurality of micro-services, each micro-service executing one or more FSM tasks associated with an asset;
providing, by the one or more processors, at least one presentation layer comprising a plurality of channels, through which a user communicates with the FSP platform;
receiving, by a virtual agent, and through a channel of the one or more channels, input data from one of the user and the asset;
transmitting, by the virtual agent, at least a portion of the input data to an artificial intelligence (AI) system;
receiving, by the virtual agent, response data from the AI system, the response data representing an intent;
initiating, by the one or more processors, at least one micro-service to perform at least one FSM task based on the intent, the at least one micro-service being performed based on interactions between the user and the virtual agent to progress through a work-flow of the at least one micro-service; and
storing, by the one or more processors, interaction data and asset data in a distributed ledger system (DLS).

2. The method of claim 1, wherein the input data comprises text data received through a messaging application of the at least one presentation layer, the text data being processed by a natural language processing (NLP) engine of the AI system to determine the intent.

3. The method of claim 1, wherein the input data comprises asset parameter data representative of operating conditions of the asset, the asset parameter data being processed by a machine-learned model of the AI system to determine the intent.

4. The method of claim 1, wherein the at least one FSM task comprises registering, by a registration service of the FSM platform, the asset to be managed by the FSM platform, registering comprising determining an asset-specific fingerprint, and submitting a registration entry to the DLS based on the asset-specific fingerprint.

5. The method of claim 1, wherein the at least one FSM task comprises initiating an incident for the asset, the incident comprising performing maintenance on the asset.

6. The method of claim 5, further comprising executing a scheduling micro-service to schedule a maintenance visit of a technician to the asset.

7. The method of claim 6, further comprising, during the maintenance visit, transmitting one or more of asset-related data, and asset-specific data to a device of the technician, the one or more of asset-related data, and asset-specific data being displayed as one or more overlays in one or more of a virtual reality (VR), augmented reality (AR), and merged reality (MR) environment provided by the device to assist the technician in resolving the incident.

8. The method of claim 5, further comprising storing audit data to the DLS upon completion of the maintenance.

9. One or more non-transitory computer-readable storage media coupled to one or more processors and having instructions stored thereon which, when executed by the one or more processors, cause the one or more processors to perform operations for providing a field service management (FSM) platform as a service, the operations comprising:
providing a services layer comprising a plurality of micro-services, each micro-service executing one or more FSM tasks associated with an asset;
providing at least one presentation layer comprising a plurality of channels, through which a user communicates with the FSP platform;
receiving, by a virtual agent, and through a channel of the one or more channels, input data from one of the user and the asset;
transmitting, by the virtual agent, at least a portion of the input data to an artificial intelligence (AI) system;
receiving, by the virtual agent, response data from the AI system, the response data representing an intent;
initiating at least one micro-service to perform at least one FSM task based on the intent, the at least one micro-service being performed based on interactions between the user and the virtual agent to progress through a work-flow of the at least one micro-service; and
storing interaction data and asset data in a distributed ledger system (DLS).

10. The computer-readable storage media of claim 9, wherein the input data comprises text data received through a messaging application of the at least one presentation layer, the text data being processed by a natural language processing (NLP) engine of the AI system to determine the intent.

11. The computer-readable storage media of claim 9, wherein the input data comprises asset parameter data representative of operating conditions of the asset, the asset parameter data being processed by a machine-learned model of the AI system to determine the intent.

12. The computer-readable storage media of claim 9, wherein the at least one FSM task comprises registering, by a registration service of the FSM platform, the asset to be managed by the FSM platform, registering comprising determining an asset-specific fingerprint, and submitting a registration entry to the DLS based on the asset-specific fingerprint.

13. The computer-readable storage media of claim 9, wherein the at least one FSM task comprises initiating an incident for the asset, the incident comprising performing maintenance on the asset.

14. The computer-readable storage media of claim 13, wherein operations further comprise executing a scheduling micro-service to schedule a maintenance visit of a technician to the asset.

15. The computer-readable storage media of claim 14, wherein operations further comprise, during the maintenance visit, transmitting one or more of asset-related data, and asset-specific data to a device of the technician, the one or more of asset-related data, and asset-specific data being displayed as one or more overlays in one or more of a virtual reality (VR), augmented reality (AR), and merged reality (MR) environment provided by the device to assist the technician in resolving the incident.

16. The computer-readable storage media of claim 13, wherein operations further comprise storing audit data to the DLS upon completion of the maintenance.

17. A system, comprising:
one or more processors; and
a computer-readable storage device coupled to the one or more processors and having instructions stored thereon which, when executed by the one or more processors, cause the one or more processors to perform operations for providing a field service management (FSM) platform as a service, the operations comprising:
providing a services layer comprising a plurality of micro-services, each micro-service executing one or more FSM tasks associated with an asset;
providing at least one presentation layer comprising a plurality of channels, through which a user communicates with the FSP platform;
receiving, by a virtual agent, and through a channel of the one or more channels, input data from one of the user and the asset;
transmitting, by the virtual agent, at least a portion of the input data to an artificial intelligence (AI) system;
receiving, by the virtual agent, response data from the AI system, the response data representing an intent;
initiating at least one micro-service to perform at least one FSM task based on the intent, the at least one micro-service being performed based on interactions between the user and the virtual agent to progress through a work-flow of the at least one micro-service; and
storing interaction data and asset data in a distributed ledger system (DLS).

18. The system of claim 17, wherein the input data comprises text data received through a messaging application of the at least one presentation layer, the text data being processed by a natural language processing (NLP) engine of the AI system to determine the intent.

19. The system of claim 17, wherein the input data comprises asset parameter data representative of operating conditions of the asset, the asset parameter data being processed by a machine-learned model of the AI system to determine the intent.

20. The system of claim 17, wherein the at least one FSM task comprises registering, by a registration service of the FSM platform, the asset to be managed by the FSM platform, registering comprising determining an asset-specific fingerprint, and submitting a registration entry to the DLS based on the asset-specific fingerprint.

21. The system of claim 17, wherein the at least one FSM task comprises initiating an incident for the asset, the incident comprising performing maintenance on the asset.

22. The system of claim 21, wherein operations further comprise executing a scheduling micro-service to schedule a maintenance visit of a technician to the asset.

23. The system of claim 22, wherein operations further comprise, during the maintenance visit, transmitting one or more of asset-related data, and asset-specific data to a device of the technician, the one or more of asset-related data, and asset-specific data being displayed as one or more overlays in one or more of a virtual reality (VR), augmented reality (AR), and merged reality (MR) environment provided by the device to assist the technician in resolving the incident.

24. The system of claim 21, wherein operations further comprise storing audit data to the DLS upon completion of the maintenance.
